(19) United States
(12) Patent Application Publication
(10) Pub. No.: US 2020/0063023 A1
(43) Pub. Date: Feb. 27, 2020

(54) PROPPANT STABILIZED WATER IN OIL EMULSIONS FOR SUBTERRANEAN APPLICATIONS

(71) Applicant: Halliburton Energy Services, Inc., Houston, TX (US)

(72) Inventors: Monica Rajendra Dandawate, Pune (IN); Prashant Chopade, Kingwood, TX (US); Rajender Salla, Pune (IN)

(73) Assignee: Halliburton Energy Services, Inc., Houston, TX (US)

(21) Appl. No.: 16/090,799

(22) PCT Filed: Jun. 17, 2016
(86) PCT No.: PCT/US2016/038109

§ 371 Date: Oct. 2, 2018

(51) Int. Cl. C09K 8/80; C09K 8/82; E21B 43/267

(52) U.S. Cl. CPC C09K 8/805; E21B 43/267; C09K 8/82

(57) ABSTRACT

A method of servicing a wellbore in a subterranean foil cation by providing a wellbore servicing fluid comprising an oil external emulsion, wherein the oil external emulsion comprises an emulsifier, water, suspended proppant particulates, and an oil external phase comprising an oleaginous fluid; and introducing the wellbore servicing fluid into the wellbore in the subterranean formation. A method of forming a wellbore servicing fluid by combining a proppant with an oleaginous fluid to provide an oleaginous fluid-coated proppant; combining the oleaginous fluid-coated proppant with an emulsifier and water; and mixing the oleaginous fluid-coated proppant, the emulsifier, and the water to form an oil external emulsion. A wellbore servicing fluid containing an oil external emulsion comprising a proppant, an oil external phase containing an oleaginous fluid, an emulsifier, and water. A well servicing system is also provided.

### BACKGROUND

The present disclosure generally relates to fluids for use in subterranean applications and methods of making and using same. More particularly, this disclosure relates to water in oil emulsions formed without the use of surface modifying agents and/or with reduced oil volumes, and utilizing such emulsified fracturing fluids to transport proppant particulates in a subterranean formation.

Subterranean wells (e.g., hydrocarbon fluid producing wells and water producing wells) are often stimulated by hydraulic fracturing treatments. In a typical hydraulic fracturing treatment, a treatment fluid is pumped into a wellbore in a subterranean formation at a rate and pressure above the fracture gradient of the particular subterranean formation so as to create or enhance at least one fracture therein. Particulate solids (e.g., graded sand, bauxite, ceramic, nut hulls, and the like), or ‘proppant particulates’, are typically suspended in the treatment fluid or a second treatment fluid and deposited into the fractures while maintaining pressure above the fracture gradient. The proppant particulates are generally deposited in the fracture in a concentration sufficient to form a tight pack of proppant particulates, or ‘proppant pack’, which serves to prevent the fracture from fully closing once the hydraulic pressure is removed. By keeping the fracture from fully closing, the interstitial spaces between individual proppant particulates in the proppant pack form conductive pathways through which produced fluids may flow.

In traditional hydraulic fracturing treatments, the specific gravity of the proppant particulates may be high in relation to the treatment fluids in which they are suspended for transport and deposit in a target interval (e.g., a fracture). Therefore, the proppant particulates may settle out of the treatment fluid and fail to reach the target interval. For example, where the proppant particulates are to be deposited into a fracture, the proppant particulates may settle out of the treatment fluid and accumulate only or substantially at the bottommost portion of the fracture, which may result in complete or partial occlusion of the portion of the fracture where no proppant particulates have collected (e.g., at the top of the fracture). As such, fracture conductivity and production over the life of a subterranean well may be substantially impaired if proppant particulates settle out of the treatment fluid before reaching their target interval within a subterranean formation.

Surface modifying agents play a vital role in altering the wettability of particulates. Varieties of surface modifying agents are known to produce stable emulsions in the presence of micro/nano-sized particles. Such emulsions that are stabilized by solid particles (such as colloidal silica) which adsorb onto the interface between the two phases are sometimes referred to as ‘Pickering’ emulsions. Existing emulsified fluids for fracturing applications conventionally utilize surface modifying agents (hereinafter, ‘SMA’s). These SMAs are generally very expensive and tend to cause operational issues due to their extremely tacky nature. Furthermore, conventional emulsions require about 30 volume percent oil.

The degree of success of a hydraulic fracturing operation depends, at least in part, upon fracture conductivity after the fracturing operation has ceased and production commenced, which conductivity is provided only when proppant is effectively positioned within the target interval. Accordingly, an ongoing need exists for compositions, and methods of making and using same, which provide for more economical and/or enhanced hindering of the settling of proppant particulates in a wellbore treatment fluid utilized during, for example, hydraulic fracturing and conformance applications.

### BRIEF DESCRIPTION OF THE DRAWINGS

The following figures are included to illustrate certain aspects of the present disclosure, and should not be viewed as providing exclusive embodiments. The subject matter disclosed herein is capable of considerable modification, alteration, and equivalents in form and function, as will occur to one having ordinary skill in the art and having the benefit of this disclosure.

FIG. 1 depicts an embodiment of a system configured for delivering the wellbore treatment fluids of the embodiments described herein to a downhole location;

FIG. 2A is a representative picture of a formulation of Example 2 tested at 325° F. (162.8° C.); and

FIG. 2B is a representative picture of a formulation of Example 2 tested at 350° F. (176.7° C.).

### DETAILED DESCRIPTION

The present disclosure provides a composition of an emulsified fluid system for fracturing applications, and methods of making and using same, which provide for proppant suspension during transportation of proppants in vertical and horizontal wells and/or in a fracture. The composition is a proppant stabilized water in oil emulsion that exhibits suitable proppant suspension despite being formed without the conventional use of SMAs and/or with reduced volumes of oil relative to conventional fracturing fluids.

As noted hereinabove, existing emulsified fluids for fracturing applications utilize surface modifying agents (SMAs), such as SANDWEDGE® and FINESWEDGE®. These SMAs are generally very expensive and some create operational issues due to the extremely tacky nature thereof. The current disclosure provides a method of using oil as a replacement for surface modification agents to produce the disclosed water in oil (e.g., proppant stabilized water in oil) emulsions. This disclosure also provides for formation of emulsions via proppants/sand having a desired mineralogy, which emulsions have conventionally been very difficult or impossible to form.

As noted above, this disclosure provides a method of making an oil external emulsion which eliminates the need for a surface modifying agent by coating oil onto the surface of sand or other proppant. The oil used to coat the sand or other proppant is the same oil that is conventionally used for preparing such emulsions, and the method of making the emulsion involves simple mixing procedures. Emulsions formed via the disclosed method provided enhanced stability relative to emulsions formed without initially coating the sand or proppant with the oil. As discussed further hereinbelow, the stability of the latter was, in some cases, found to be only a few minutes at a given temperature. The cost of the herein disclosed fluid can be at least about four times less than that of conventionally prepared proppant stabilized water in oil emulsions.

This disclosure eliminates the need for utilizing a surface modification agent simply by altering the order of mixing of the oil and the sand/proppant, without altering the desired characteristics of the resulting fluid/emulsion. In embodiments, the disclosed method also enables preparation of stable emulsions utilizing larger size particles (e.g., 20-40 mesh), rather than requiring micro and/or nano-sized proppant particles. As discussed in more detail hereinbelow, the desired stability of the emulsion is obtained via usage of a specific volumetric ratio of emulsifier and oil (1:5); having at least this ratio is desirable, although increasing the emulsifier to oil ratio doesn't negatively impact on the properties of the formed emulsion. As noted hereinabove, oil-based emulsions typically require about 30 volume percent oil, however, the current disclosure provides for the formation of stable emulsions with a much reduced oil content (about 5 volume percent oil, in some embodiments).

Herein disclosed is a method of servicing in a wellbore in a subterranean formation, the method comprising: preparing a wellbore servicing fluid comprising an oil external emulsion, wherein the oil external emulsion comprises an emulsifier, water, suspended proppant particulates, and an oil external phase comprising an oleaginous fluid; and introducing the wellbore servicing fluid into the wellbore in the subterranean formation. In embodiments, the oil external emulsion comprises from about 1 to about 10 volume percent of the oleaginous fluid. In embodiments, the oil external emulsion comprises less than 10 volume percent of the oleaginous fluid. In embodiments, the oil external emulsion comprises less than or equal to about 5 volume percent of the oleaginous fluid. In embodiments, the volumetric ratio of the emulsifier to the oleaginous fluid in the oil external emulsion is at least or equal to 1:5. In embodiments, the proppant particulates are 20/40 mesh or larger. In embodiments, the oil external emulsion is stable for at least 50 hours at temperatures of at least 200° F. (93.3° C.). In embodiments, the oil external emulsion is stable for at least 5 hours at temperatures of at least 350° F. (176.7° C.). In embodiments, the oil external emulsion further comprises divalent ions.

In embodiments, the oil external emulsion is formed without a surface modifying agent. In embodiments, the method further comprises forming the oil external emulsion by combining the proppant particulates with the oleaginous fluid to coat the proppant particulates therewith prior to combining the oleaginous fluid-coated proppant particulates with the emulsifier and the water, and agitating to form the oil external emulsion. In embodiments, the proppant particulates are coated with the oleaginous fluid substantially immediately before combining the oleaginous fluid-coated proppant particulates with the emulsifier and the water. In embodiments, the wellbore in the subterranean formation comprises at least one fracture, and introducing the wellbore servicing fluid comprising the proppant particulates into the wellbore in the subterranean formation further comprises placing at least a portion of the proppant particulates into the at least one fracture. In embodiments, the wellbore servicing fluid comprises from about 0.1 ppg (12 kg/m³) to about 10 ppg (1200 kg/m³) of the proppant particulates, based on the total volume of the wellbore servicing fluid.

Also disclosed herein is a method of forming a wellbore servicing fluid, the method comprising: combining a proppant with an oleaginous fluid to provide an oleaginous fluid-coated proppant; combining the oleaginous fluid-coated proppant with an emulsifier and water; and mixing the oleaginous fluid-coated proppant, the emulsifier, and the water to form an oil external emulsion. In embodiments, combining the oil-coated proppant with the emulsifier and water is performed substantially immediately subsequent combining the proppant with the oleaginous fluid to provide the oleaginous fluid-coated proppant. In embodiments, the oil external emulsion comprises from about 1 to about 10 volume percent of the oleaginous fluid. In embodiments, the oil external emulsion comprises less than 10 volume percent of the oleaginous fluid. In embodiments, the oil external emulsion comprises less than or equal to about 5 volume percent of the oleaginous fluid. In embodiments, the volumetric ratio of the emulsifier to the oleaginous fluid in the oil external emulsion is at least or equal to 1:5. In embodiments, the proppant is 20/40 mesh or larger. In embodiments, the oil external emulsion is stable for at least 50 hours at temperatures of at least 200° F. (93.3° C.). In embodiments, the oil external emulsion is formed in the absence of a surface modifying agent. In embodiments, the wellbore servicing fluid comprises from about 0.1 ppg (12 kg/m³) to about 10 ppg (1200 kg/m³) of the proppant, based on the total volume of the wellbore servicing fluid. In embodiments, mixing further comprises adjusting an initial position of a stirrer to induce the oil external emulsion.

Also disclosed herein is a wellbore servicing fluid comprising: an oil external emulsion comprising a proppant, an oil external phase containing an oleaginous fluid, an emulsifier, and water. In embodiments, the oil external emulsion comprises from about 1 to about 10 volume percent of the oleaginous fluid. In embodiments, the oil external emulsion comprises less than 10 volume percent of the oleaginous fluid. In embodiments, the oil external emulsion comprises less than or equal to about 5 volume percent of the oleaginous fluid. In embodiments, the volumetric ratio of the emulsifier to the oleaginous fluid in the oil external emulsion is at least or equal to 1:5. In embodiments, the proppant is 20/40 mesh or larger. In embodiments, the oil external emulsion is stable for at least 50 hours at temperatures of at least 200° F. (93.3° C.). In embodiments, the wellbore servicing fluid comprises no surface modifying agent. In embodiments, the wellbore servicing fluid comprises from about 0.1 ppg (12 kg/m³) to about 10 ppg (1200 kg/m³) of the proppant, based on the total volume of the wellbore servicing fluid.

General Measurement Terms

Unless otherwise specified or unless the context otherwise clearly requires, any ratio or percentage means by volume.

If there is any difference between U.S. or Imperial units, U.S. units are intended.

Unless otherwise specified, mesh sizes are in U.S. Standard Mesh.

The micrometer (μm) may sometimes be referred to herein as a micron.

The conversion between pound per gallon (lb/gal or ppg) and kilogram per cubic meter (kg/m³) is: 1 lb/gal=(1 lb/gal)×(0.4536 kg/lb)×(gal/0.003785 m³)=120 kg/m³.

The features and advantages provided by the fracturing fluid of this disclosure will be readily apparent to those skilled in the art upon a reading of the following description of the embodiments. As noted hereinabove, the present disclosure relates to fracturing fluid systems comprising emulsions prepared without SMAs and/or with reduced amounts (e.g., less than 10 volume percent, in embodiments) of oil. More specifically, the present disclosure provides, in embodiments, wellbore treatment fluids that are produced in the absence of SMAs and/or with reduced volume percentages of oil, yet provide suitable emulsion stability for a variety of applications.

Although the description that follows is primarily directed to fracturing fluids and conductivity enhancement via utilization of such fluids, wellbore treatment fluids containing like particulates (e.g., gravel packing fluids comprising gravel) may also be produced by making use of the present disclosure, and such applications are intended to be within the scope of this disclosure.

Of the many advantages of the present disclosure, only a few of which are discussed or alluded to herein, the present disclosure generally provides cost-effective, more facile, and/or environmentally friendly, methods for preparing and utilizing stable emulsified fluids that provide viscosity and temperature stability suitable for use during a range of fracturing applications. The herein-disclosed emulsified fluid system provides for efficient proppant suspension and transportation, due to extended particulate (e.g., proppant) settling time, and the elimination, in embodiments, of the use of generally operationally-challenging and expensive SMAs. Fracturing fluids according to this disclosure may exhibit comparable or improved stability, for example, in the presence of significant quantities of produced water and/or sea water containing high salt levels (in the presence of which conventional fracturing fluids tend to lose viscosity, resulting in proppant settling) and/or at higher than previously considered temperatures. For example, the fracturing fluids of this disclosure may exhibit comparable or enhanced stability relative to fracturing fluids containing more oil and/or produced via the conventional usage of SMAs, and/or may be stable at comparable or even higher temperatures and/or in the presence of greater volumes of salt water and/or production water than conventional fracturing fluids. For example, in embodiments, the fracturing fluids of this disclosure are stable at temperatures of greater than 180° F. (82.2° C.), 200° F. (93.3° C.), 250° F. (121.1° C.), 300° F. (148.9° C.), 325° F. (162.8° C.), or 350° F. (176.7° C.), and/or in the presence of 0.01% to 40% (w/v) of salt water and/or production water. Formation of the emulsion via the disclosed method of making occurs on the order of seconds; such rapid emulsion formation may translate into time savings during fluid preparation in during field operations. The price per barrel of oil equivalent may be reduced by improving the conductivity of unconventional reservoirs via the improved proppant suspension provided by the herein-disclosed wellbore treatment fluids and methods.

As noted hereinabove, the present disclosure also provides methods of forming the herein-disclosed wellbore treatment fluids, as detailed further hereinbelow. Oil external emulsions according to the present disclosure may advantageously be formed via the introduction of the proppant thereto prior to pumping downhole. In this manner, the emulsion structure of the treatment fluid and the distribution of the particulate (e.g., proppant) therein may be stabilized.

As noted hereinabove, the present disclosure also provides methods of using wellbore treatment fluids according to this disclosure. In some embodiments, the methods comprise providing a wellbore treatment fluid comprising an oil external emulsion according to this disclosure and containing an external oil phase, a particulate (e.g., proppant, gravel), an emulsifier, and water, and placing the wellbore treatment fluid in a subterranean formation via a wellbore penetrating the subterranean formation. Although referred to herein as a ‘treatment’ fluid, it is to be understood that the oil external emulsion according to this disclosure may be suitable for a variety of fluids utilized in a wellbore, as will be apparent to one of ordinary skill in the art.

Particulate/Proppant

The applications in which the methods and emulsion of the present disclosure may be used include any subterranean operation where suspending proppant particulates, or other solid particles, may be of benefit. For example, in some embodiments, the oil external treatment fluids of the present disclosure may be utilized to transport proppant particulates into an at least one fracture within a subterranean formation. Therein, the proppant particulates may form a proppant pack capable of holding open the fracture during production of the well.

Wellbore treatment fluids according to this disclosure comprise a particulate. In embodiments, the particulate is a proppant comprising sized particles mixed with the fracturing fluid to hold fractures open after a hydraulic fracturing treatment. The proppant particulates for use in the methods of the present disclosure may comprise any material suitable for use in subterranean operations. The proppant may be natural or synthetic, or may comprise a combination of natural and synthetic material. Suitable materials for the proppant particulates include, but are not limited to, sand; bauxite; ceramic materials; glass materials; polymer materials; polytetrafluoroethylene materials; nut shell pieces; cured resinous particulates comprising nut shell pieces; seed shell pieces; cured resinous particulates comprising seed shell pieces; fruit pit pieces; cured resinous particulates comprising fruit pit pieces; wood; composite particulates; and any combination thereof. Suitable composite particulates may comprise a binder and a filler material wherein suitable filler materials include, but are not limited to, silica; alumina; fumed carbon; carbon black; graphite; mica; titanium dioxide; meta-silicate; calcium silicate; kaolin; talc; zirconia; boron; fly ash; hollow glass microspheres; solid glass; and any combination thereof.

As noted above, the disclosed method of making the water in oil (e.g., proppant stabilized water in oil) emulsion (which is described in more detail hereinbelow) may enable for the usage of larger sized proppant particulates than conventionally utilized. Without limitation, the mean proppant particulate size generally may range from about 2 mesh to about 400 mesh on the U.S. Sieve Series; however, in certain circumstances, other mean proppant particulate sizes may be desired and will be entirely suitable for practice of the present disclosure. In particular embodiments, preferred mean particulates size distribution ranges are one or more of 6/12, 8/16, 12/20, 16/30, 20/40, 30/50, 40/60, 40/70, or 50/70 mesh. It should be understood that the term ‘proppant particulate’, as used in this disclosure, includes all known shapes of materials, including substantially spherical materials; fibrous materials; polygonal materials (e.g., cubic materials); and any combination thereof. Moreover, fibrous materials, that may or may not be used to bear the pressure of a closed fracture, may be included in certain embodiments of the present disclosure. In certain embodiments, the particulates may be present in the oil external treatment fluid of the present invention in an amount in the range of from about 0.5 pounds per gallon or ppg (60 kg/m³) to about 30 ppg (3600 kg/m³), from about 3 ppg (360 kg/m³) to about 20 ppg (2400 kg/m³), from about 5 pounds per gallon (600 kg/m³) to about 10 ppg (1200 kg/m³) by volume of the treatment fluid.

Emulsifier(s)

A wellbore treatment fluid according to this disclosure comprises at least one emulsifier. Examples of suitable emulsifiers may include, but are not limited to, surfactants, proteins, hydrolyzed proteins, lipids, glycolipids, nanosized particulates (e.g., fumed silica), fatty alcohol sulphates, fatty alcohol ether-sulphates, alkyl sulphonates, carboxymethylated fatty alcohol oxethylates, fatty alcohol (ether) phosphates, fatty alcohol ethersulphosuccinates, alkyl betaines, fatty alcohol oxethylates, fatty acid oxethylates, fatty acid esters of polyhydric alcohols or of ethoxylated polyhydric alcohols (sorbitan esters), sugar fatty acid esters, fatty acid partial glycerides, glycerides with fatty acids and polybasic carboxylic acids, and the like.

Oil external emulsions according to this disclosure can comprise a volumetric ratio of emulsifier to oil that is greater than or equal to about 1:5.

Aqueous and Oil Phases

Wellbore treatment fluids according to this disclosure comprise an aqueous phase comprising an aqueous fluid and an oil phase comprising an oleaginous fluid or hydrocarbon. In embodiments, the wellbore treatment fluid is water-based, and comprises an aqueous base fluid. In embodiments, the wellbore treatment fluid of this disclosure is an oil external emulsion comprising an oil external phase and an aqueous internal phase.

Aqueous Phase: As used herein, the term ‘aqueous fluid’ refers to a material comprising water or a water-miscible but oleaginous fluid-immiscible compound. Illustrative aqueous fluids suitable for use in embodiments of this disclosure include, for example, fresh water, sea water, a brine containing at least one dissolved organic or inorganic salt, a liquid containing water-miscible organic compounds, and the like.

The aqueous fluid or base fluid of the present embodiments can generally be from any source, provided that the fluids do not contain components that might adversely affect the stability and/or performance of the wellbore treatment fluids of the present disclosure. In various embodiments, the aqueous fluid can comprise fresh water, salt water, seawater, brine, or an aqueous salt solution. In some embodiments, the aqueous fluid can comprise a monovalent brine or a divalent brine. Suitable monovalent brines can include, for example, sodium chloride brines, sodium bromide brines, potassium chloride brines, potassium bromide brines, and the like. Suitable divalent brines can include, for example, magnesium chloride brines, calcium chloride brines, calcium bromide brines, and the like. In some embodiments, the aqueous base fluid can be a high density brine. As used herein, the term ‘high density brine’ refers to a brine that has a density of about 9.5-10 lbs/gal or greater (1.1 g/cm³-1.2 g/cm³ or greater).

Oil Phase: A wellbore treatment fluid of this disclosure comprises an oil phase. In embodiments, a wellbore treatment fluid according to this disclosure comprises an oil external phase. The oil phase comprises an oleaginous fluid, which may include one or more hydrocarbon. As used herein, the term ‘oleaginous fluid’ refers to a material having the properties of an oil or like non-polar hydrophobic compound. Illustrative oleaginous fluids suitable for use in embodiments of this disclosure include, for example, (i) esters prepared from fatty acids and alcohols, or esters prepared from olefins and fatty acids or alcohols; (ii) linear alpha olefins, isomerized olefins having a straight chain, olefins having a branched structure, isomerized olefins having a cyclic structure, and olefin hydrocarbons; (iii) linear paraffins, branched paraffins, poly-branched paraffins, cyclic paraffins and isoparaffins; (iv) mineral oil hydrocarbons; (v) glyceride triesters including, for example, rapeseed oil, olive oil, canola oil, castor oil, coconut oil, corn oil, cottonseed oil, lard oil, linseed oil, neatsfoot oil, palm oil, peanut oil, perilla oil, rice bran oil, safflower oil, sardine oil, sesame oil, soybean oil and sunflower oil; (vi) naphthenic compounds (cyclic paraffin compounds having a formula of CₙH₂ₙ where n is an integer ranging between about 5 and about 30); (vii) diesel; (viii) aliphatic ethers prepared from long chain alcohols; and (ix) aliphatic acetals, dialkylcarbonates, and mixtures thereof. As used herein, fatty acids and alcohols or long chain acids and alcohols refer to acids and alcohols containing about 6 to about 22 carbon atoms, or about 6 to about 18 carbon atoms, or about 6 to about 14 carbon atoms. In some embodiments, such fatty acids and alcohols have about 6 to about 22 carbon atoms comprising their main chain. One of ordinary skill in the art will recognize that the fatty acids and alcohols may also contain unsaturated linkages.

In embodiments, in a wellbore treatment fluid according to this disclosure, an oleaginous fluid external phase and an aqueous fluid internal phase are present in a ratio of less than about 50:50. This ratio is commonly stated as the oil-to-water ratio (OWR). That is, in the present embodiments, a wellbore treatment fluid having a 50:50 OWR comprises 50% oleaginous fluid external phase and 50% aqueous fluid internal phase. In embodiments, drilling fluids according to this disclosure have an OWR ranging between about 5:95 to about 35:65, including all sub-ranges therein between. In embodiments, drilling fluids of this disclosure have an OWR ranging between about 1:99 and about 10:90, including all sub-ranges therein between. In embodiments, the drilling fluids have an OWR of about 10:90 or less. In embodiments, the drilling fluids have an OWR of about 5:95 or less. One of ordinary skill in the art will recognize that lower OWRs can more readily form emulsions that are suitable for suspending sand and other proppants therein. However, one of ordinary skill in the art will also recognize that an OWR that is too low may prove overly viscous for downhole pumping.

In embodiments, an oil external emulsion treatment fluid according to this disclosure comprises a less than conventional volume percentage of oil. For example, in embodiments, a wellbore treatment fluid according to this disclosure comprises from about 1 to about 10, from about 2 to about 9, or from about 3 to about 8 volume percent oil, based on the total volume of the treatment fluid. In embodiments, a wellbore treatment fluid according to this disclosure comprises less than or equal to about 30, 25, 20, 15, 10, 9, 8 7, 6, 5, 4, or 3 volume percent oil, based on the total volume of the treatment fluid.

Other Additives

A wellbore treatment fluid of this disclosure may optionally comprise any number of additional additives known to those of skill in the art to be suitable for use in such wellbore treatment fluids. Examples of such additional additives include, without limitation, surfactants, gelling agents, fluid loss control agents, corrosion inhibitors, rheology control modifiers or thinners, viscosity enhancers, temporary viscosifying agents, filtration control additives, high temperature/high pressure control additives, surfactants, alkalinity agents, pH buffers, gases, nitrogen, carbon dioxide, foamers, scale inhibitors, catalysts, clay control agents, biocides, bactericides, friction reducers, antifoam agents, bridging agents, dispersants, flocculants, H₂S scavengers, CO₂ scavengers, oxygen scavengers, friction reducers, breakers, relative permeability modifiers, resins, wetting agents, coating enhancement agents, filter cake removal agents, surfactants, defoamers, shale stabilizers, oils, and the like. One or more of these additives (e.g., bridging agents) may comprise degradable materials that are capable of undergoing irreversible degradation downhole. A person skilled in the art, with the benefit of this disclosure, will recognize the types of additives that may be included in the drilling fluids of the present disclosure for a particular application, without undue experimentation.

Surface Modifying Agents: In embodiments, a wellbore treatment fluid according to this disclosure is formed without the use of a surface modifying agent, tackifying agents, or the like.

Method of Making Wellbore Treatment Fluid

Also disclosed herein is a method of making a wellbore treatment fluid comprising an oil external emulsion. The method of forming a wellbore treatment or servicing fluid comprising an oil external emulsion according to this disclosure comprises combining a proppant with the oil to provide an oil-coated proppant; combining the oil-coated proppant with an emulsifier and water; and agitating to form the oil external emulsion. In embodiments, it is advantageous to combine the oil-coated proppant with the emulsifier and water substantially immediately subsequent combining the proppant with the oil to provide the oil-coated proppant. Generally, formation of the emulsion will occur within a few seconds.

In embodiments, the oil external emulsion comprises from about 1 to about 10 volume percent oil, from about 2 to about 9 volume percent oil, or from about 3 to about 8 volume percent oil, based on the total volume of the oil external emulsion. In embodiments, the oil external emulsion comprises less than about 30, 25, 20, 15, 10, 9, 8, 7, 6, or 5 volume percent oil, based on the total volume of the oil external emulsion.

In embodiments, the volumetric ratio of the emulsifier to the oil in the oil external emulsion is at least 1:5. In embodiments, the volumetric ratio of the emulsifier to the oil in the oil external emulsion is greater than 1:5. In embodiments, the volumetric ratio of the emulsifier to the oil in the oil external emulsion is equal to about 1:5.

In embodiments, the oil external emulsion is formed in the absence of a surface modifying agent.

The wellbore servicing fluid can comprise from about 0.1 ppg (12 kg/m³) to about 10 ppg (1200 kg/m³) of the proppant, based on the total volume of the wellbore servicing fluid. The wellbore servicing fluid can comprise from about 0.5 ppg (60 kg/m³) to about 10 ppg (1200 kg/m³) of the proppant, based on the total volume of the wellbore servicing fluid. In embodiments, the proppant is 20/40 mesh or larger.

In embodiments, the addition of divalent ions (e.g., calcium and/or magnesium ions) is utilized to enhance the stability of the oil external emulsion of this disclosure at elevated temperatures, such as at or above 250° F. (121.1° C.), 300° F. (148.9° C.), 325° F. (162.8° C.), or 350° F. (176.7° C.). The addition of calcium and/or magnesium ions may thus serve to enhance the stability above 250° F. (121.1° C.).

In embodiments, the initial location of the stirrer in the emulsification vessel is placed in such a way to be in more contact with the oil coated proppant to induce the resulting emulsion. When the proppant/sand is coated with oil according to this disclosure, the surface area is increased and available to form the desired emulsion. In embodiments, a combination of stirrer location and oil coating onto the proppant is utilized to provide a proppant stabilized emulsion.

Increasing the quantity of oil and emulsifier may improve temperature stability, and therefore one of skill in the art, without undue experimentation, can easily optimize the oil external emulsion provided herein to enable utilization of the disclosed fluid system for a broad range of downhole conditions.

As noted above, the proppant particulates may advantageously be incorporated in a wellbore treatment fluid according to this disclosure prior to introduction of the wellbore treatment fluid in a subterranean formation. Such wellbore treatment fluids may be formulated at a production facility and mixed by applying a shearing force to the treatment fluid to produce an emulsion. Once formed, the emulsion may be stable in the absence of a shearing force, such that the wellbore treatment fluids of the present disclosure have a reduced tendency toward proppant precipitation. In embodiments, separation of the proppant particles is reduced or inhibited for at least or equal to about 60, 70, 80, 90, 100, 110, or 120 minutes. As evidenced via Examples 1 and 2 hereinbelow, oil external emulsions prepared according to this disclosure provide excellent elasticity that enables proppant suspension for increased durations (e.g., up to 50 hours, in embodiments) over a wide range of temperatures (e.g., including at least 200° F. (93.3° C.) and/through 350° F. (176.7° C.)). In embodiments, the emulsion is stable for at least 20, 30, 40, or 50 hours at temperatures of at least or equal to about 180° F. (82.2° C.), 200° F. (93.3° C.), 250° F. (121.1° C.), 300° F. (148.9° C.), 325° F. (162.8° C.), or 350° F. (176.7° C.).

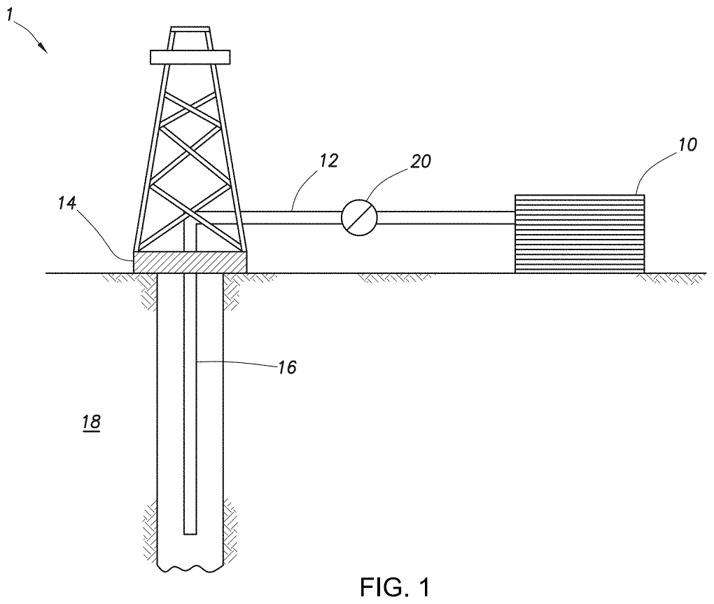

In embodiments, the disclosed wellbore treatment fluid may be prepared at a well site or at an offsite location. Once prepared, a treatment fluid of the present disclosure may be placed in a tank, bin, or other container for storage and/or transport to the site where it is to be used. In other embodiments, a treatment fluid of the present disclosure may be prepared on-site, for example, using continuous mixing, on-the-fly mixing, or real-time mixing methods. In certain embodiments, these methods of mixing may include methods of combining two or more components wherein a flowing stream of one element is continuously introduced into flowing stream of another component so that the streams are combined and mixed while continuing to flow as a single stream as part of the on-going treatment. The system depicted in FIG. 1 (described further hereinbelow) may be one embodiment of a system and equipment used to accomplish on-the-fly or real-time mixing.

Methods of Use

Also disclosed herein are methods of introducing a wellbore treatment according to this disclosure into a wellbore. The methods of the present disclosure may be employed in any subterranean application where a treatment fluid of this disclosure may be suitable. In an embodiment, a method of treating a wellbore comprises providing a wellbore treatment fluid according to this disclosure, and using the wellbore treatment fluid during a stimulating operation. The treatment fluid may be used in conjunction with any downhole operation for which it is suitable, as will be apparent to those of skill in the art.

The methods and wellbore fluid compositions of the present disclosure may be used during or in conjunction with any operation in a portion of a subterranean formation and/or wellbore, and may be particularly suitable for hydraulic fracturing applications and/or conformance applications. For example, the methods and/or compositions of the present disclosure may be used in the course of hydraulic fracturing operations in which the herein-disclosed oil external emulsion fracturing fluid may be pumped at high pressure and rate into a reservoir interval to be treated, causing a vertical fracture(s) to open, thus enhancing conductivity.

The wellbore treatment fluids of the present disclosure may be provided and/or introduced into the wellbore in a subterranean formation using any method or equipment known in the art. In certain embodiments, a wellbore fluid of the present disclosure may be circulated in the wellbore using the same types of pumping systems and equipment at the surface that are used to introduce drilling fluids and/or other treatment fluids or additives into a wellbore penetrating at least a portion of the subterranean formation.

FIG. 1 shows an illustrative schematic of a system that can deliver treatment fluids of the embodiments disclosed herein to a downhole location, according to one or more embodiments. It should be noted that while FIG. 1 generally depicts a land-based system, it is to be recognized that like systems may be operated in subsea locations as well. As depicted in FIG. 1, system 1 may include mixing tank 10, in which a treatment fluid of the embodiments disclosed herein may be formulated. The treatment fluid may be conveyed via line 12 to wellhead 14, where the treatment fluid enters tubular 16, tubular 16 extending from wellhead 14 into subterranean formation 18. Upon being ejected from tubular 16, the treatment fluid may subsequently penetrate into subterranean formation 18. Pump 20 may be configured to raise the pressure of the treatment fluid to a desired degree before its introduction into tubular 16. It is to be recognized that system 1 is merely exemplary in nature and various additional components may be present that have not necessarily been depicted in FIG. 1 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 1, the treatment fluid may, in some embodiments, flow back to wellhead 14 and exit subterranean formation 18. In some embodiments, the treatment fluid that has flowed back to wellhead 14 may subsequently be recovered and recirculated to subterranean formation 18.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 1.

The invention having been generally described, the following Examples are given as particular embodiments of this disclosure and to demonstrate the practice and advantages thereof. It is to be understood that the Examples are given by way of illustration only, and are not intended to limit the specification or the claims to follow in any manner. The below test results clearly indicate that the herein-disclosed oil coating method has significant importance in forming stable oil external emulsions without compromising the emulsion properties; although specific compositions are provided in the below Examples, such compositions can, without undue experimentation, be modified with a variety of emulsifiers, oils and other components without departing from the scope of this disclosure.

### EXAMPLES

### Example 1: Comparison of Emulsions Formed with and without SMAs

Two proppant stabilized water in oil emulsions were formed, one proppant stabilized water in oil emulsion formed via a conventional method utilizing a SMA (Procedure A, hereinbelow), and a second proppant stabilized water in oil emulsion formed via the inventive method absent the use of an SMA (Procedure B, hereinbelow).

Procedure A:

Thirty-six grams (6 ppg (720 kg/m³)) of Brady sand (as proppant) was taken in a beaker and coated with 0.05 mL of SANDWEDGE® SMA available from Halliburton Energy Services in Houston, Tex., ensuring uniform coating of the SMA over the sand/proppant. An amount of 2.38 mL of oil (LCA-1 paraffinic oil available from Halliburton Energy Services, in Houston, Tex., or ESCAID-110 low viscosity, hydrotreated, light hydrocarbon oil, available from ExxonMobil in Houston, Tex.) was added to the mixture, followed by the addition of 0.5 mL of an emulsifier (EZMUL®-NT, BROMI-MUL™, or FORTI-MUL®, respectively, each available from Halliburton Energy Services in Houston, Tex.) and 47.62 mL of water. The mixture was subsequently stirred under an overhead stirrer at 600 rpm to 1150 rpm for respective compositions. The stability of the formed emulsion was tested under static conditions in a water bath at 200° F. (93.3° C.).

Emulsion stability was measured by taking the emulsion comprising proppant in a glass bottle and maintaining the bottle in a water bath at 200° F. (93.3° C.) until it broke. Breaking of the emulsion was determined by periodically measuring the volume of water generated versus time. For temperatures above 200° F. (93.3° C.), emulsion comprising proppant was taken in a graduated glass liner/cylinder, followed by application of a pressure of about 600 psi in an autoclave. Timely removal and measurement of the generated water volume indicates the emulsion stability.

Procedure B:

Procedure B is the same procedure as described in procedure A, with the exception that the sand/proppant was coated with the entirety of the oil, as per this disclosure, rather than with an SMA, followed by the addition of the emulsifier and the water. Procedure B thus doesn't utilize SMA in preparing the emulsion. Note: this procedure benefits from rapid addition and stirring of the remaining components subsequent coating of the sand/proppant with the oil; delay in mixing the remaining components may influence the stability and emulsion forming tendency of the fluid.

Table 1 below provides a summary of the various formulations prepared as per Procedure A and Procedure B above. As can be seen from the data in Table 1, emulsions formulated utilizing various emulsifiers and oils and having an emulsifier to oil volumetric ratio of 1:5 and an absence of SMA exhibited excellent stability (in each case maintaining stability for at least 32 hours). The results illustrate that the inventive oil coating method has significant importance in forming stable oil external emulsions without compromising required properties. Upon reading this disclosure, one of ordinary skill in the art will, without undue experimentation, be able to prepare a variety of formulations with a range of emulsifiers, oils and/or other components.

TABLE 1
Summary of Various Formulations of Example 1 Tested at 200° F. (93.3° C.)

| | | | | Oil | Duration | |
|---|---|---|---|---|---|---|
| | | | | Coated | for | |
| | | | | on | Forming | |
| | | Emulsifier:Oil, | | Brady | Emulsion | Stability |
| Emulsifier | Oil | Vol. Ratio | SMA | Sand | (seconds) | (hours) |
| EZMUL ®- | LCA-1 | 1:5 | SandWedge ®- | NO | 13 to 16 | ~56 |
| NT | | | NT | | | |
| EZMUL ®- | LCA-1 | 1:5 | | YES | 13 to 16 | ~56 |
| NT | | | | | | |
| EZMUL ®- | Escaid ™- | 1:5 | SandWedge ®- | NO | 50 to 56 | ~48 |
| NT | 110 | | NT | | | |
| EZMUL ®- | Escaid ™- | 1:5 | | YES | 50 to 56 | ~46 |
| NT | 110 | | | | | |
| BROMI- | LCA-1 | 1:5 | SandWedge ®- | NO | 5 to 10 | ~100 |
| MUL ™ | | | NT | | | |
| BROMI- | LCA-1 | 1:5 | | YES | 5 to 10 | ~54 |
| MUL ™ | | | | | | |
| BROMI- | Escaid ™- | 1:5 | SandWedge ®- | NO | 55 to 59 | ~70 |
| MUL ™ | 110 | | NT | | | |
| BROMI- | Escaid ™- | 1:5 | | YES | 55 to 59 | ~42 |
| MUL ™ | 110 | | | | | |
| FORTI- | LCA-1 | 1:5 | SandWedge ®- | NO | 20 to 25 | ~56 |
| MUL ® | | | NT | | | |
| FORTI- | LCA-1 | 1:5 | | YES | 20 to 25 | ~32 |
| MUL ® | | | | | | |

### Example 2: Stability of Proppant Stabilized Water in Oil Emulsions Formed without SMAs

Formulations prepared according to Procedure B (and thus containing no SMA), and containing BROMI-MUL™ emulsifier and ESCAID™-110 oil in a 1:5 volumetric ratio were prepared and tested for emulsion stability at elevated temperatures, and in the presence of 47.62 mL of sea water as the water component. Table 2 below provides the compositions, preparation, and results obtained with these formulations at elevated temperatures of 325° F. (162.8° C.) and 350° F. (176.7° C.).

TABLE 2
Summary of Various Formulations of Example 1 Tested above 300° F. with
SeaWater

| | | | | Oil | Duration | | |
|---|---|---|---|---|---|---|---|
| | | | | Coated | for | | |
| | | | | on | Forming | | Stability |
| | | Emulsifier:Oil, | | Brady | Emulsion | Temp., | Tested |
| Emulsifier | Oil | Vol. Ratio | SMA | Sand | (Seconds) | ° F. (° C.) | (hours) |
| BROMI- | Escaid ™- | 1:5 | NO | YES | 10 to 55 | 350 | ~4.0 |
| MUL ™ | 110 | | | | | (176.7) | |
| BROMI- | Escaid ™- | 1:5 | NO | YES | 10 to 55 | 325 | ~7.5 |
| MUL ™ | 110 | | | | | (162.8) | |

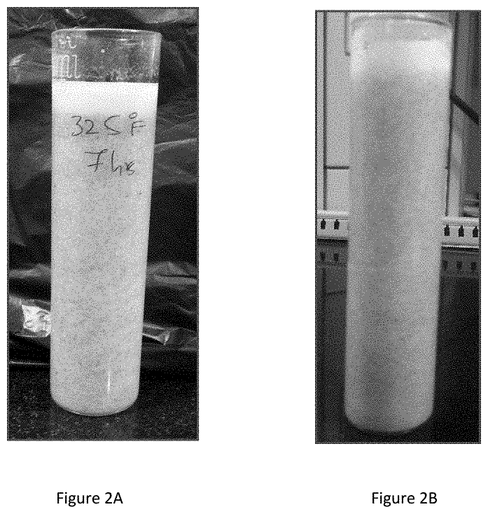

FIG. 2A is a representative picture of a formulation tested at 325° F. (162.8° C.), and FIG. 2B is a representative picture of a formulation tested at 350° F. (176.7° C.). FIGS. 2A and 2B illustrate the emulsion stability and proppant suspending capability after 7 hours.

### Example 3: Effect of Proppant Type on Formation Time of Inventive Emulsion

To determine if/how the nature of the proppant and its mineralogy effect the formation of the disclosed emulsions absent SMAs, emulsion formation with a variety of proppants was investigated. Table 4 summarizes the results on emulsion formation time obtained with three proppants having differing specific gravity, density, and mineralogy. Table 3 provides the mineralogy of the three studied proppants, which included UNIFRAC® 20/40 proppant available from Unimin Energy Solutions in The Woodlands, Tex., ceramic proppants, and lightweight proppants having mesh size between 20 and 40 mesh. The UNIFRAC® 20/40 proppant has a specific gravity of 2.54 and a bulk density of 99.5 lb/ft³ (1.59 g/cm³). The ceramic proppant had a specific gravity of 1.85 and a bulk density of 203 lb/ft³ (3.25 g/cm³). The lightweight proppant 20/40 had a specific gravity of 2.75 and a bulk density of 94 lb/ft³ (1.50 g/cm³). Emulsions were formed as described in Example 2. As seen from the data in Table 4, the nature of the proppant/proppant type has an impact on the emulsion formation time, with the lightweight proppants and the ceramic proppants having emulsion formation times less than half that of the heavier UNIFRAC® 20/40 proppant.

TABLE 3
Mineralogy of Proppants Studied in Example 3

| | Ceramic | Light weight | UNIFRAC ® |
|---|---|---|---|
| Phase | proppants | proppants 20/40 | 20/40 |
| Quartz, SiO₂ | 2 | 2 | 97 |
| Anhydrite, CaSO₄ | — | — | 2 |
| Dolomite, CaMg(CO₃)₂ | — | — | trace |
| Pyrite, FeS₂ | — | — | trace |
| Aluminum Silicate | 98 | — | — |
| Aluminum Oxide, Al2O3 | — | 96 | — |
| Mg—Fe—Ti-Oxide | — | — | — |
| Ti—Fe—Al-Oxide | — | 2 | — |

TABLE 4
Effect of Proppant Type on Emulsion Formation Time

| | Emulsion Formation |
|---|---|
| Proppant Sample | Time (s) |
| UNIFRAC ® 20/40 | 85 |
| Ceramic Proppant | 40 |
| Lightweight Proppant 20/40 | 35 |

Irrespective of the minerology of the proppant, when coated with hydrophobic resin/tackifier, the corresponding coated proppant was able to provide the desired water in oil emulsion.

The present disclosure is well adapted to attain the ends and advantages mentioned herein, as well as those that are inherent therein. A fracturing fluid comprising no SMA and/or reduced volumetric percentage of oil according to this disclosure may exhibit significantly enhanced stability, and may facilitate economic production and utilization of such wellbore treatment fluids, for example by enabling the usage of a greater variety of proppants (e.g., larger sizes thereof), and/or usage over a wider temperature range and/or range of viscosities. The elimination of the need for SMAs may, in embodiments, enable formation of more environmentally friendly, less costly, and/or operationally simpler fracturing fluids. The (low cost) emulsified fluid system and methods disclosed herein may provide improved proppant suspension for fracturing applications.

The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent or other documents, the definitions that are consistent with this specification should be adopted.

Embodiments disclosed herein include:

A: A method of servicing a wellbore in a subterranean formation, the method comprising: providing a wellbore servicing fluid comprising an oil external emulsion, wherein the oil external emulsion comprises an emulsifier, water, suspended proppant particulates, and an oil external phase comprising an oleaginous fluid; and introducing the wellbore servicing fluid into the wellbore in the subterranean formation.

B: A method of forming a wellbore servicing fluid, the method comprising: combining a proppant with an oleaginous fluid to provide an oleaginous fluid-coated proppant; combining the oleaginous fluid-coated proppant with an emulsifier and water; and mixing the oleaginous fluid-coated proppant, the emulsifier, and the water to form an oil external emulsion.

C: A wellbore servicing fluid comprising: an oil external emulsion comprising a proppant, an oil external phase containing an oleaginous fluid, an emulsifier, and water.

D: A well servicing system comprising: a well treatment apparatus, including at least one mixer and a pump, configured to: combine a proppant with an oleaginous fluid to provide an oleaginous fluid-coated proppant; combine the oleaginous fluid-coated proppant with an emulsifier and water to form a pre-emulsified fluid; mix the pre-emulsified fluid to form an oil external emulsified fluid; and introduce the oil external emulsified fluid into a subterranean formation.

Each of embodiments A, B, C, and D may have one or more of the following additional elements: Element 1: wherein the oil external emulsion comprises from about 1 to about 10 volume percent of the oleaginous fluid. Element 2: wherein the oil external emulsion comprises less than 10 volume percent of the oleaginous fluid. Element 3: wherein the oil external emulsion comprises less than or equal to about 5 volume percent of the oleaginous fluid. Element 4: wherein the volumetric ratio of the emulsifier to the oleaginous fluid in the oil external emulsion is at least or equal to 1:5. Element 5: wherein the proppant particulates are 20/40 mesh or larger. Element 6: wherein the oil external emulsion is stable for at least 50 hours at temperatures of at least 200° F. (93.3° C.). Element 7: wherein the oil external emulsion is stable for at least 5 hours at temperatures of at least 350° F. (176.7° C.). Element 8: wherein the oil external emulsion further comprises divalent ions. Element 9: wherein the wellbore servicing fluid comprises no surface modifying agent. Element 10: further comprising forming the oil external emulsion by combining the proppant particulates with the oleaginous fluid to coat the proppant particulates therewith prior to combining the oleaginous fluid-coated proppant particulates with the emulsifier and the water, and agitating to form the oil external emulsion. Element 11: wherein combining the oleaginous fluid-coated proppant with the emulsifier and water is performed substantially immediately subsequent combining the proppant with the oleaginous fluid to provide the oleaginous fluid-coated proppant. Element 12: wherein the proppant particulates are coated with the oleaginous fluid substantially immediately before combining the oleaginous fluid-coated proppant particulates with the emulsifier and the water. Element 13: wherein the wellbore in the subterranean formation comprises at least one fracture, and wherein introducing the wellbore servicing fluid comprising the proppant particulates into the wellbore in the subterranean formation further comprises placing at least a portion of the proppant particulates into the at least one fracture. Element 14: wherein the wellbore servicing fluid comprises from about 0.1 ppg (12 kg/m³) to about 10 ppg (1200 kg/m³) of the proppant/proppant particulates, based on the total volume of the wellbore servicing fluid. Element 15: wherein mixing further comprises adjusting an initial position of a stirrer to induce the emulsion.

While preferred embodiments of the invention have been shown and described, modifications thereof can be made by one skilled in the art without departing from the teachings of this disclosure. The embodiments described herein are exemplary only, and are not intended to be limiting. Many variations and modifications of the invention disclosed herein are possible and are within the scope of the invention. Use of the term “optionally” with respect to any element of a claim is intended to mean that the subject element is required, or alternatively, is not required. Both alternatives are intended to be within the scope of the claim.

Numerous other modifications, equivalents, and alternatives, will become apparent to those skilled in the art once the above disclosure is fully appreciated. It is intended that the following claims be interpreted to embrace all such modifications, equivalents, and alternatives where applicable.

What is claimed is:

1. A method of servicing a wellbore in a subterranean formation, the method comprising:
providing a wellbore servicing fluid comprising an oil external emulsion, wherein the oil external emulsion comprises an emulsifier, water, suspended proppant particulates, and an oil external phase comprising an oleaginous fluid; and
introducing the wellbore servicing fluid into the wellbore in the subterranean formation.

2. The method of claim 1, wherein the oil external emulsion comprises from about 1 to about 10 volume percent of the oleaginous fluid.

3. The method of claim 2, wherein the oil external emulsion comprises less than 10 volume percent of the oleaginous fluid.

4. The method of claim 2, wherein the oil external emulsion comprises less than or equal to about 5 volume percent of the oleaginous fluid.

5. The method of claim 1, wherein the volumetric ratio of the emulsifier to the oleaginous fluid in the oil external emulsion is at least or equal to 1:5.

6. The method of claim 1, wherein the proppant particulates are 20/40 mesh or larger.

7. The method of claim 1, wherein the oil external emulsion is stable for at least 50 hours at temperatures of at least 200° F. (93.3° C.).

8. The method of claim 7, wherein the oil external emulsion is stable for at least 5 hours at temperatures of at least 350° F. (176.7° C.).

9. The method of claim 8, wherein the oil external emulsion further comprises divalent ions.

10. The method of claim 1, wherein the wellbore servicing fluid comprises no surface modifying agent.

11. The method of claim 1 further comprising forming the oil external emulsion by combining the proppant particulates with the oleaginous fluid to coat the proppant particulates therewith prior to combining the oleaginous fluid-coated proppant particulates with the emulsifier and the water, and agitating to form the oil external emulsion.

12. The method of claim 11, wherein the proppant particulates are coated with the oleaginous fluid substantially immediately before combining the oleaginous fluid-coated proppant particulates with the emulsifier and the water.

13. The method of claim 1, wherein the wellbore in the subterranean formation comprises at least one fracture, and wherein introducing the wellbore servicing fluid comprising the proppant particulates into the wellbore in the subterranean formation further comprises placing at least a portion of the proppant particulates into the at least one fracture.

14. The method of claim 1, wherein the wellbore servicing fluid comprises from about 0.1 ppg (12 kg/m³) to about 10 ppg (1200 kg/m³) of the proppant particulates, based on the total volume of the wellbore servicing fluid.

15. A method of forming a wellbore servicing fluid, the method comprising:
combining a proppant with an oleaginous fluid to provide an oleaginous fluid-coated proppant;
combining the oleaginous fluid-coated proppant with an emulsifier and water; and
mixing the oleaginous fluid-coated proppant, the emulsifier, and the water to form an oil external emulsion.

16. The method of claim 15, wherein combining the oleaginous fluid-coated proppant with the emulsifier and water is performed substantially immediately subsequent combining the proppant with the oleaginous fluid to provide the oleaginous fluid-coated proppant.

17. The method of claim 15, wherein the oil external emulsion comprises from about 1 to about 10 volume percent of the oleaginous fluid.

18. The method of claim 17, wherein the oil external emulsion comprises less than 10 volume percent of the oleaginous fluid.

19. The method of claim 17, wherein the oil external emulsion comprises less than or equal to about 5 volume percent of the oleaginous fluid.

20. The method of claim 15, wherein the volumetric ratio of the emulsifier to the oleaginous fluid in the oil external emulsion is at least or equal to 1:5.

21. The method of claim 15, wherein the proppant is 20/40 mesh or larger.

22. The method of claim 15, wherein the oil external emulsion is stable for at least 50 hours at temperatures of at least 200° F. (93.3° C.).

23. The method of claim 15, wherein the wellbore servicing fluid comprises no surface modifying agent.

24. The method of claim 15, wherein the wellbore servicing fluid comprises from about 0.1 ppg (12 kg/m³) to about 10 ppg (1200 kg/m³) of the proppant, based on the total volume of the wellbore servicing fluid.

25. The method of claim 15, wherein mixing further comprises adjusting an initial position of a stirrer into the oil coated particulates to induce the emulsion.

26. A wellbore servicing fluid comprising:
an oil external emulsion comprising a proppant, an oil external phase containing an oleaginous fluid, an emulsifier, and water.

27. The wellbore servicing fluid of claim 26, wherein the oil external emulsion comprises from about 1 to about 10 volume percent of the oleaginous fluid.

28. The wellbore servicing fluid of claim 26, wherein the oil external emulsion comprises less than 10 volume percent of the oleaginous fluid.

29. The wellbore servicing fluid of claim 26, wherein the oil external emulsion comprises less than or equal to about 5 volume percent of the oleaginous fluid.

30. The wellbore servicing fluid of claim 26, wherein the volumetric ratio of the emulsifier to the oleaginous fluid in the oil external emulsion is at least or equal to 1:5.

31. The wellbore servicing fluid of claim 26, wherein the proppant is 20/40 mesh or larger.

32. The wellbore servicing fluid of claim 26, wherein the oil external emulsion is stable for at least 50 hours at temperatures of at least 200° F. (93.3° C.).

33. The wellbore servicing fluid of claim 26, wherein the wellbore servicing fluid comprises no surface modifying agent.

34. The wellbore servicing fluid of claim 26, wherein the wellbore servicing fluid comprises from about 0.1 ppg (12 kg/m³) to about 10 ppg (1200 kg/m³) of the proppant, based on the total volume of the wellbore servicing fluid.

35. A well servicing system comprising:
a well treatment apparatus, including at least one mixer and a pump, configured to:
combine a proppant with an oleaginous fluid to provide an oleaginous fluid-coated proppant;
combine the oleaginous fluid-coated proppant with an emulsifier and water to form a pre-emulsified fluid;
mix the pre-emulsified fluid to form an oil external emulsified fluid; and
introduce the oil external emulsified fluid into a subterranean formation.
